(19) United States
(12) Patent Application Publication
(10) Pub. No.: US 2008/0192610 A1
(43) Pub. Date: Aug. 14, 2008

(54) Optical System with 3 Spot Radial Tracking

(75) Inventors: Ruud Vlutters, Eindhoven (NL); Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,297

(22) PCT Filed: Jun. 1, 2006
(86) PCT No.: PCT/IB06/51758

§ 371 Date: Dec. 3, 2007

(30) Foreign Application Priority Data
Jun. 6, 2005 (EP) 05104893.2

(51) Int. Cl. G11B 7/00

(52) U.S. Cl. 369/112.01

(57) ABSTRACT

The present invention relates to an optical system for reproducing and/or recording on optical record carrier. The system includes light providing means for providing at least: 1) a main beam for reading information, and 2) a plurality of auxiliary beams for radial tracking; a first (A), a second (B) and a third (C) auxiliary beam. The optical record carrier has readable effects arranged in tracks (2, 12) in one or more spiral(s), the spiral(s) being separated by one or more guard band(s) (5, 15). The optical system performs radial tracking from the reflected light of 1) the first auxiliary beam (A), the first auxiliary beam being positioned in a first guard band, and 2) the second (B) and third auxiliary beam (C). The second auxiliary beam is positioned on a first track (I), and the third auxiliary beam (C) is positioned on a second track (II) and on opposite side of the first guard band (5, 15) relative to the second auxiliary beam (B). The optical system provides improved radial tracking on the above-mentioned carrier format.

The present invention relates to an optical system for reproducing and/or recording optically readable effects on an associated optical record carrier and performing stable radial tracking on the optical record carrier. The invention further relates to a method for reproducing and/or recording optically readable effects on an associated optical record carrier.

In order to meet the demand of increasing information storage capacity the available optical media, i.e. compact disc (CD), digital versatile disc (DVD) and the Blu-ray Disc (BD), show a constant improvement in storage capacity. In these optical media, the reproduction resolution has hitherto been mostly dominated by the wavelength, λ, of the reproduction light and the numerical aperture (NA) of the optical reproduction apparatus. However, since it is not easy to shorten the wavelength of the reproduction light or to increase the numerical aperture of the corresponding lens system, attempts to increase the recording density has pre-dominantly been focused at improving the recording media and/or the recording/reproduction method.

In particular, for optical media adapted for recording information two different approaches have been suggested: The land-groove format wherein information is recorded both in the groove of the track and next to the groove, and the groove-only format wherein the information is only recorded in the groove, e.g. the BD disc format. Both of these formats have advantages and disadvantages, in particular with respect to radial tracking and inter-track/symbol cross-write/erase issues.

Presently, the density limit reached by combining a track pitch of 240 nm with a channel bit length of 50 nm has shown that the capacity of the BD-type disc can potentially be increased from the current 23-25-27 GB up to 50 GB per layer of information on the media.

However, an inherent conflict between further downscaling of the track pitch versus the need for stabile radial tracking and limited cross-write/erase problems is encountered in present state of the art discs. In particular, an optical storage method with both the advantages of the land-groove format with respect to stable radial tracking and the advantages of the groove-only format with respect to limited cross-write/erase problems is therefore desirable.

In US 2004/0076100, an optical disc for improved storage density is disclosed. This optical disc is essentially a land-groove format with dedicated pre-pit regions having a pair of wobble pits disposed between data recording regions, where the data regions are positioned in spirals or circles on the disc. The pre-pit regions are adapted for generating a radial tracking error signal. However, manufacturing of such a disc format is troublesome due to the angular separation of the pre-pit regions causing a non-uniformity of the disc. Additionally, the trade-off between the number of pre-pit regions and the radial tracking stability may inherently limit the storage density of the disc.

Hence, an improved optical tracking method would be advantageous, and in particular a more efficient and/or reliable optical system for reproducing and/or recording optically readable effects on an associated optical record carrier would be advantageous.

Accordingly, the invention preferably seeks to mitigate, alleviate or eliminate one or more of the above mentioned disadvantages singly or in any combination. In particular, it may be seen as an object of the present invention to provide an optical system that solves the above mentioned problems of the prior art with providing an optical system facilitating an increased storage density on an optical carrier.

This object and several other objects are obtained in a first aspect of the invention by providing an optical system for reproducing and/or recording optically readable effects on an associated optical record carrier the system comprising:

light providing means for providing at least:

a main beam for reading information as readable effects on the carrier and/or recording information as readable effects on the carrier, and

a plurality of auxiliary beams applicable for radial tracking, said plurality of auxiliary beams comprising a first, a second and a third auxiliary beam, photo detection means capable of detecting reflected light from the optical record carrier,

the associated optical record carrier comprising, or being adapted for recording, readable effects arranged in tracks in one or more spiral(s), said one or more spiral(s) being separated by one or more guard band(s),

wherein the optical system is adapted to perform radial tracking from the reflected light of:

the first auxiliary beam, the first auxiliary beam being positioned in a first guard band, and

the second and third auxiliary beam. the second auxiliary beam being positioned substantially on, or next to, a first track, and the third auxiliary beam being positioned substantially on, or next to, a second track and on opposite side of the first guard band relative to the second auxiliary beam.

The invention according to the first aspect is particularly but not exclusively advantageous for facilitating an optical system capable of recording/reproducing information on a carrier with a low track pitch, i.e. track width. The possibility of a lowered track pitch does not jeopardize the radial tracking as the radial tracking is to be performed in the guard bands of the associated carrier. The commonly used optical storage system with a single spiral carrier format has an inherent conflict between the radial tracking signal provided by the track and the wish to minimize the track pitch, a conflict that is solved by the present optical system.

Furthermore, the invention according to the first aspect is particularly but not exclusively advantageous for facilitating an optical system that is stable against small deviations from perfect alignment of the reflected light applied for radial tracking relative to the photo detector means for detecting said reflected light. Such misalignment may otherwise cause so-called beam landing of the main light spot used for reading/recording, i.e. the main beam may be slightly offset relative to intended radial position on the track and the reflected light of the main beam is offset on the corresponding detector. This may in turn reduce the quality of reproduction/recording, e.g., cross talk

The optical system may advantageously be arranged so that the first, second and third auxiliary beams are adapted to be substantially equidistantly positioned on the associated optical record carrier. This symmetry may readily be obtained by a using a grating as light dividing means. However, the present invention is not limited to such symmetry. Under some conditions it may be beneficial to have the e.g. the second auxiliary beam shifted forwards relative to carrier moving direction and the third auxiliary beam shifted backwards relative to carrier moving direction. This is normally the case for currently applied 3 spot push pull radial tracking.

Advantageously, the optical system may be adapted so that the separation distance in the radial direction between the first, second and third auxiliary beams is substantially equal to an integer times the track pitch (Tₚ) of the associated optical record carrier. Thus, there may be a match between the beam separation and the track pitch on the carrier, preferably the integer is equal to one, but other integers may also be applied. In some conditions, e.g. if the tracking servo system is operated in a duty cycle mode, the matching between the beam separation and the carrier may occur with a non-integer ratio.

Notice, that the second and third auxiliary beam need not be exactly on the corresponding track but may also be adjacent or a combination of being on the track and adjacent, i.e. partly on the track, as long as a sufficient push pull signal useful for generating a radial tracking error signal is obtained.

Beneficially, the first track may be adjacent to the first guard band, and the second track may be adjacent to the first guard band. Alternatively, tracks adjacent to said first and second track may be applied. Even more alternatively, said first and second track may be positioned on different spirals of readable effects not being adjacent on the carrier, i.e. that is spirals separated by one or more spirals. Said different spirals may be on the same side or on opposite side of the first guard band.

Advantageously, each track of the associated carrier may be adapted for recording and/or reproducing optically readable effects, e.g. pits, positioned substantially in a groove or a depression in the carrier. Such groove-only formats are applied for write-once and rewriteable optical media.

Preferably, the radial tracking may be performed according to the push-pull (PP) method as this method is well known in the art and may therefore be readily implemented according to the principles of the present invention.

Beneficially, the optical system may comprise at least two corresponding photo detectors for each of the first, the second and the third auxiliary beam. The at least two photo detectors can be adapted to generate a difference signal for each auxiliary beam by subtraction means, e.g. differential circuits. Additionally, wherein the optical system may be adapted to perform a normalization of each difference signal by a sum of signals representing the total intensity of reflected light on the at least two photo detectors corresponding to each difference signal. This is particular advantageous in order to overcome fluctuations in the reflected light. This may also be beneficial when the tracking is performed in a border guard band where there is only a spiral positioned on one side of the guard band. Otherwise, an incorrect tracking error signal would result.

In a second aspect, the present invention to a method for operating an optical system adapted for reproducing and/or recording optically readable effects on an associated optical record carrier, the method comprising the steps of:

providing light providing means capable of emitting at least:

a main beam for reading information as readable effects on the carrier and/or recording information as readable effects on the carrier, and

a plurality of auxiliary beams applicable for radial tracking, said plurality of auxiliary beams comprising a first, a second and a third auxiliary beam,

providing photo detection means capable of detecting reflected light from the optical record carrier,

the associated optical record carrier comprising, or being adapted for recording, readable effects arranged in tracks in one or more spiral(s), said one or more spiral(s) being separated by one or more guard band(s),

wherein the optical system is adapted to perform radial tracking by:

detecting the reflected light of the first auxiliary beam, the first auxiliary beam being positioned in a first guard band, and

the reflected light of the second and third auxiliary beam, the second auxiliary beam being positioned substantially on, or next to, a first track, and the third auxiliary beam being positioned substantially on, or next to, a second track and on opposite side of the first guard band relative to the second auxiliary beam.

In a third aspect, the invention relates to a computer program product being adapted to enable a computer system comprising at least one computer having data storage means associated therewith to control an optical system according to the second aspect of the invention.

This aspect of the invention is particularly, but not exclusively, advantageous in that the present invention may be implemented by a computer program product enabling a computer system to perform the operations of the second aspect of the invention. Thus, it is contemplated that some known optical system may be changed to operate according to the present invention by installing a computer program product on a computer system controlling the said optical system. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

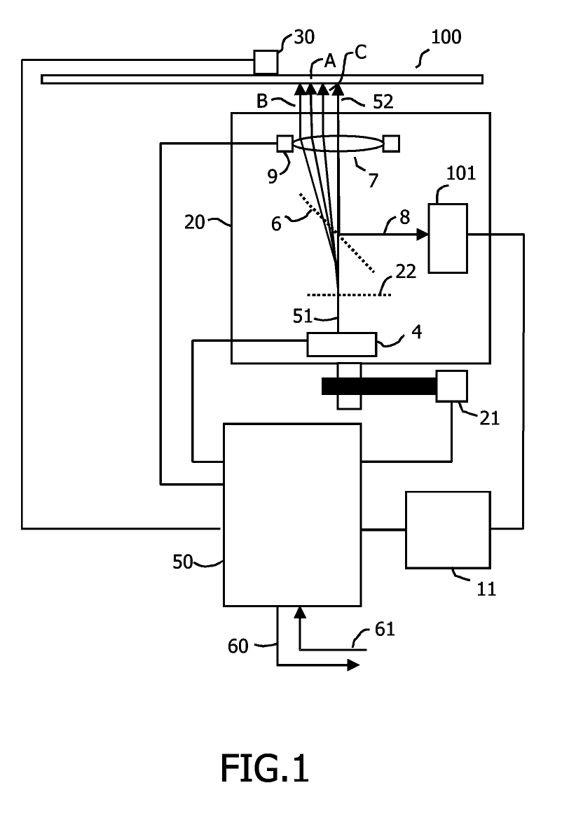

FIG. 1 is a schematic drawing of an optical system according to the first aspect of the invention,

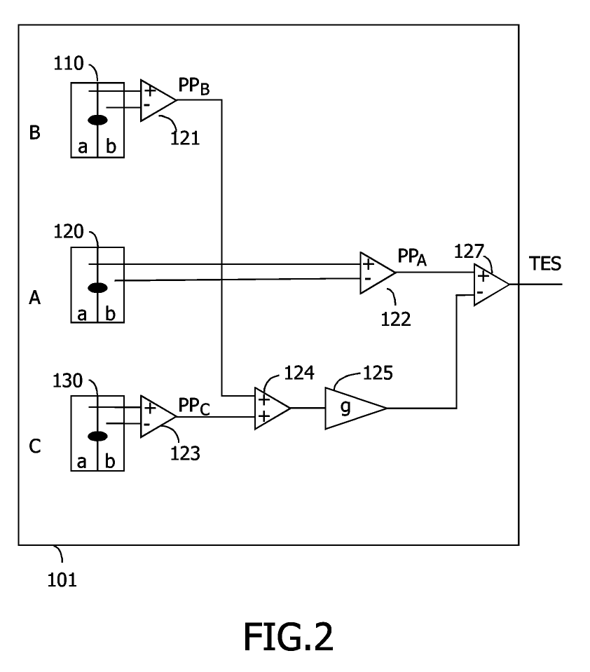

FIG. 2 is a schematic drawing of photo detection means according to the first aspect of the invention,

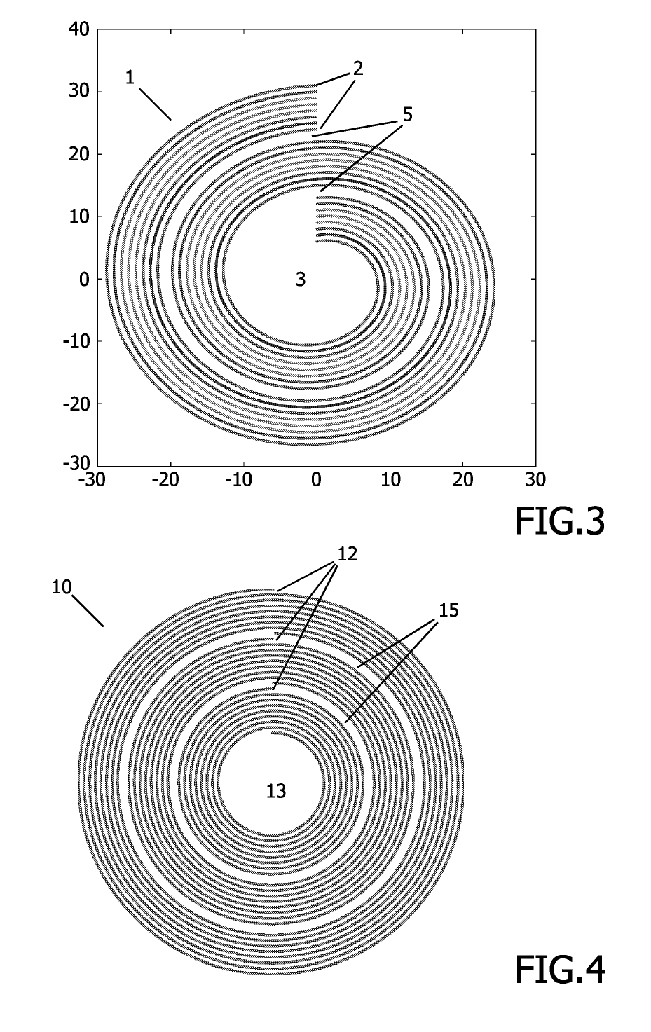

FIG. 3 is a schematic drawing of a carrier format particular suited for operation with the optical system according to the first aspect of the invention,

FIG. 4 is a schematic drawing of another carrier format particular suited for operation with the optical system according to the first aspect of the invention,

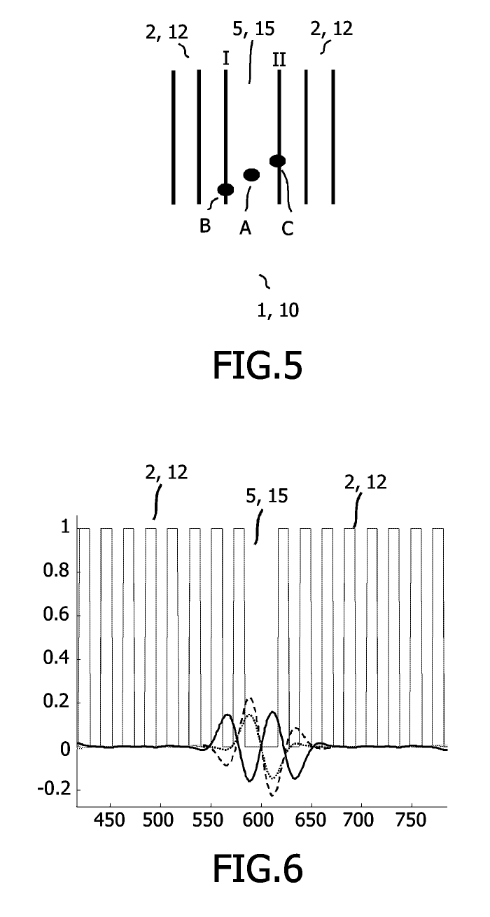

FIG. 5 is a schematic drawing of the position of the first, second and third auxiliary beam on the associated carrier according to the present invention,

FIG. 6 is shows a vertical-radial cross-section of a carrier superimposed with various push pull (PP) signals,

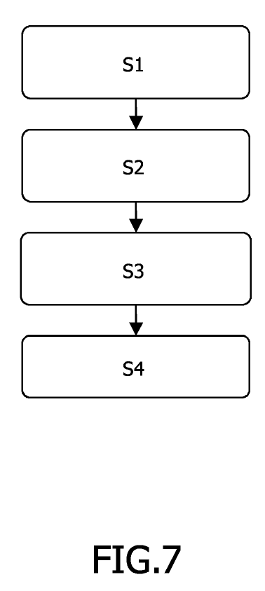

FIG. 7 is a flow chart illustrating the method according to the second aspect of the invention.

FIG. 1 schematically shows an optical system and associated optical carrier 100 according to the invention. The carrier 100 is fixed and rotated by holding means 30.

The carrier 100 comprises a material suitable for recording information by means of a radiation beam 52. The term “radiation beam” is used interchangeable with the term “light beam” throughout this application. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 100. However, the carrier may alternatively be of a read-only-memory (ROM) format.

The apparatus comprises an optical head 20, sometimes called an optical pick-up (OPU), the optical head 20 being displaceable by actuation means 21, e.g. an electric stepping motor. The optical head 20 comprises a photo detection system 101, a radiation source 4, a beam splitter 6, an objective lens 7, and lens displacement means 9. The optical head 20 also comprises light dividing means 22, such as a grating or a holographic pattern that is capable of splitting the radiation beam 51 into at least four components 52, A, B, and C where A, B, C may denote the first, second and third order diffraction, respectively, on the left side of the zero-order main beam 52. However, for changing the radial position of the main beam 52 for reading/recording at desired track it is necessary for the three auxiliary beams A, B, C to be changeable in position relative to the main beam 52.

For reason of the clarity just the radiation beam 52 and the three auxiliary beams A, B, C are shown after passing through the beam splitting means 22 but more auxiliary spots are typically present if e.g. the light dividing means 22 is a grating. Similarly, the radiation 8 reflected also comprises more than one component, e.g. the reflections of the three spots A, B, C, and diffractions thereof, but only one beam 8 is shown in FIG. 1 for clarity. The radiation source 4 for emitting a radiation beam 52 can for example be a semiconductor laser with a variable power, possibly also with variable wavelength of radiation. Alternatively, the radiation source 4 may comprise more than one laser. The radiation source 4, light dividing means 22, and the lens 7 may be considered to be light providing means within the context of the present invention.

The function of the photo detection system 101 is to convert radiation 8 reflected from the carrier 100 into electrical signals. Thus, the photo detection system 101 comprises several photo detectors, e.g. photodiodes, charged-coupled devices (CCD), etc., capable of generating one or more electric output signals that are transmitted to a pre-processor 11. The photo detectors are arranged spatially to one another, and with a sufficient time resolution so as to enable detection of focus (FE) and radial tracking (RTE) errors in the pre-processor 11. Thus, the pre-processor 11 transmits focus (FE) and radial tracking error (RTE) signals to the processor 50. The photo detection system 101 can also transmit a read signal or RF signal representing the information being read from the carrier 100 by the main beam 52 to the processor 50 through the pre-processor 11. The read signal may possibly converted to a central aperture (CA) signal by a low-pass filtering of the RF signal in the processor 50.

The optical head 20 is optically arranged so that the radiation beam 52 is directed to the optical carrier 100 via a beam splitter 6, and an objective lens 7. Additionally, a collimator lens (not shown) may be present before the objective lens 7. Radiation 8 reflected from the carrier 100 is collected by the objective lens 7 and, after passing through the beam splitter 6, falls on a photo detection system 101 which converts the incident radiation 8 to electric output signals as described above.

The processor 50 receives and analyses output signals from the pre-processor 11. The processor 50 can also output control signals to the actuation means 21, the radiation source 4, the lens displacement means 9, the pre-processor 11, and the holding means 30, as illustrated in FIG. 1. Similarly, the processor 50 can receive data, indicated at 61, and the processor 50 may output data from the reading process as indicated at 60.

FIG. 2 is a schematic drawing of photo detection means 101 according to the first aspect of the invention. Three photo detector sections 110, 120, 130 are shown. On each of the photo detector sections 110, 120, 130, the corresponding spot, A, B, and C, respectively are shown. In the embodiment shown in FIG. 2, the photo detector sections 110, 120, 130 are divided into two photo detectors a and b. This is the normal optical configuration for performing tracking by the push-pull (PP) method, where a relative weighting between the two detectors a and b is applied for generating a radial error signal denoting the error or deviation from an intended radial position and the actual position. For simplicity, only a single spot is shown on the photodetectors 110, 120, and 130, but typically the first order diffraction lines (m=±1) are present as well. By relative weighting between the detectors marked a and b three push-pull signal PP_{A}, PP_{B}, PP_{C} are obtained for each photodetector section 110, 120, and 130 by the subtraction circuits 121, 122, and 123. Thus, the push-pull signals PP_{A}, PP_{B}, PP_{C} are calculated. As shown in FIG. 3, the PP_{B} is added to PP_{C} by the addition circuit 124. Subsequently, the sum of PP_{B} and PP_{C} is adjusted by the term g in the multiplication circuit 125, g typically being equal to 0.5.

The components of the push-pull signal PP_{A}, PP_{B}, PP_{C} may be averaged by other methods by e.g. normalizing by the sum of the light on the photo detectors a and b by appropriate sum circuits (not shown). Finally, the adjusted and summed second and third auxiliary beam push pull signal is subtracted from the first auxiliary beam push pull signal by the subtraction circuit 127 and a tracking error signal (TES), or a radial error (RE), is obtained and transmitted to the processor 50.

In FIGS. 3 and 4, two particular formats of an optical carrier format 1 that are well suited for being applied by an optical system according to the present invention are illustrated. In the embodiment of FIGS. 3, 4, 5, and 6 the carrier format is a format with tracks having grooves, e.g. write-once and rewriteable carriers. However, it should be stressed that the principle of the present invention is not limited to such formats.

FIG. 3 is a schematic drawing of a carrier format particular suited for operation with the optical system according to the first aspect of the invention. A plurality of tracks 2 are disposed substantially spirally and substantially concentrically with respect to central position 3 on the carrier. Each track 2 is adapted for recording and/or reproducing optically readable effects positioned substantially in a groove i.e. a depression (not shown).

The plurality of tracks 2 are arranged adjacently in a multi-track spiral 1 on the optical record carrier and the number of tracks in FIG. 3 is eight. The number of tracks 2 in the broad spiral 1 is determined by a compromise between the radial servo system complexity and the storage capacity decrease due to the fact that the guard band 5 contains no data or possibly that the data density in the guard band 5 is lower than in the grooves of the broad spiral. The number of tracks 2 may also be: 2, 3, 4, 5, 6, 7, 8, 9, 10, 11, 12, 13, 14, 15, 16, 17, 18, 19, and 20. The tracking area 5 between the windings of the multi-track spiral 1 is adapted for providing a radial tracking error signal from the optical carrier 100.

FIG. 4 is a schematic drawing of another carrier format 10 particular suited for operation with an optical system according to the first aspect of the invention. A plurality of tracks 12 are disposed substantially spirally and substantially concentrically with respect to a central position 13 on the carrier. Each track 12 is adapted for recording and/or reproducing optically readable effects positioned substantially in a groove (not shown). The plurality of spirals 10 are arranged in concentric consecutive layers 12 on the optical record carrier with one spiral in each layer similar to the structure of an onion. In FIG. 4, just three consecutive spirals 12 are shown for clarity but for an actual carrier 100 the number of spirals 12 or “onion-shelves” may vary by any number between 2 and 1.000.000. The tracking areas 15 between the spirals 12 are adapted for providing a radial tracking error signal from the optical record carrier as will be further explained in FIGS. 5 and 6.

FIG. 5 is a schematic drawing of the position of the first A, the second B and third C auxiliary beam on the associated carrier 100 according an embodiment of the present invention. The first auxiliary beam A is positioned in a first guard band 5 or 15. Simultaneously, the second auxiliary beam B is positioned substantially on a first track I and the third auxiliary beam C is positioned substantially on a second track II. The second B and the third C auxiliary beam are on opposite side of the first guard band 5 or 15 relative to each other. Furthermore, the second B and the third C auxiliary beam are positioned adjacent to the guard band 5 or 15. Notice, that the second B and the third C auxiliary beam are shifted in tangential direction (vertical in the Figure) of the carrier relative to the first auxiliary beam C. This is preferred to obtain better optical separation on the photo detections means 101.

FIG. 6 shows a vertical-radial cross-section of a carrier 100 superimposed with the corresponding radial tracking error signals obtained by modelling the push-pull radial tracking error signal of the embodiment in FIG. 5. The scales of the plot are arbitrary. In FIG. 6, the radial position on the carrier 100 is plotted on the horizontal scale. On the vertical scale, the push-pull radial tracking error signal from the reflected light 8 of auxiliary spots are plotted. The plot corresponds to the auxiliary spots A, B, and C being scanned along the radial direction. The dotted line denotes the PP_{A} signal obtained from the first auxiliary beam A intended for positioning in center of the guard band 5 or 15. It is possible to apply this single spot for radial tracking but as explained earlier such a single spot method is sensitive to beam landing. The solid black line denotes the 0.5 (PP_{B}+PP_{C}) sum signal from the second B and third C auxiliary beam. Finally, the dashed line denotes the subtraction

TES=PP_{A}−0.5(PP_{B}+PP_{C}), (1)

where TES means a tracking error signal. In formula (I) all the signals are normalized. This tracking error TES obtained from the three auxiliary beams A, B and C is invariant to offsets that horizontally displace the reflected light 8 of the three auxiliary beams A, B and C simultaneously on the photo detector segments 110, 120, and 130 as shown in FIG. 2. This kinds of displacement are typically the result of lens displacement, lens tilt, displacement of OPU, manufacturing margins etc.

The physical structure of the grooves is also indicated on the vertical scale. The amplitude of 1 corresponds to the bottom of the grooves, whereas the carrier surface is positioned at amplitude of 0. Thus, as seen there are no grooves in the tracking area(s) 5 and 15.

The grooves are grouped in either a multi-spiral 1 with tracks 2 or consecutive spirals 12 in the carrier format 10. Both are 10-track-wide, and the inter-spiral separation, i.e. the tracking area(s) or guard band 5 or 15. Since the optical spot resolution is finite leading essentially to a low-pass characteristic of the channel response, the very high frequency of tracks within the broad groups 2 or 12 is not getting captured. In the given embodiment the following data applies: numerical aperture (NA)=0.85, wavelength of light=405 nm and track pitch of 220 nm with a duty circle of 50%.

As it is visible in FIG. 6, there is an almost-zero push-pull signal within the tracks 2 of the multi-spiral 1 or within the consecutive spirals 12. At the guard bands 5 or 15, however, the groove structure has a significant lower frequency component due to the larger track spacing there, and the push-pull tracking signals from the auxiliary spot A, B, and C are strong and provide clear “S-curves” around the middle of the guard band 5 and 15. This means that the auxiliary spots A, B, and C can reliably track the middle of the guard band 5 and 15 from the obtained radial tracking signals, but the individual tracks 2 of multi-spiral 1 or the consecutive spirals 12 does not give rise to a useful radial tracking error signal. In the given example, the guard band width is 3×Tₚ/2=3×120 nm=360 nm, while the push-pull signals vanish only at the spatial track spacing below 2×120 nm=240 nm for the given characteristics of the optical spot. That means that the guard band 5 and 15 can also be made narrower, down to approximately 280 nm/2=140 nm. The lower limit of the track pitch may, however, with the present state of optical detection devices be somewhat difficult to implement.

FIG. 7 is a flow chart illustrating the method according to the second aspect of the invention by providing method for operating an optical system adapted for reproducing and/or recording optically readable effects on an associated optical record carrier 100, the method comprising the steps of:

S1 providing light providing means 4, 22, and 7 capable of emitting at least:

a main beam 52 for reading information as readable effects on the carrier 100 and/or recording information as readable effects on the carrier 100, and

a plurality of auxiliary beams A, B, C applicable for radial tracking, said plurality of auxiliary beams comprising a first A, a second B and a third C auxiliary beam,

S2 providing photo detection means 101, 110, 120, 130 capable of detecting reflected light 8 from the optical record carrier 100,

the associated optical record carrier 100 comprising, or being adapted for recording, readable effects arranged in tracks in one or more spiral(s) 2 or 12, said one or more spiral(s) being separated by one or more guard band(s) 5 or 15,

wherein the optical system is adapted to perform radial tracking by:

S3 detecting the reflected light 8 of the first auxiliary beam A, the first auxiliary beam being positioned in a first guard band 5 or 15, and

S4 detecting the reflected light 8 of the second B and third auxiliary beam C, the second B auxiliary beam being positioned substantially on, or next to, a first track I, and the third C auxiliary beam being positioned substantially on, or next to, a second track II and on opposite side of the first guard band 5 or 15 relative to the second auxiliary beam B.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical system for reproducing and/or recording optically readable effects on an associated optical record carrier (100) the system comprising:
light providing means (4, 22, 7) for providing at least:
a main beam (52) for reading information as readable effects on the carrier and/or recording information as readable effects on the carrier, and
a plurality of auxiliary beams applicable for radial tracking, said plurality of auxiliary beams comprising a first (A), a second (B) and a third (C) auxiliary beam,
photo detection means (101, 110, 120, 130) capable of detecting reflected light (8) from the optical record carrier (100),
the associated optical record carrier comprising, or being adapted for recording, readable effects arranged in tracks (2, 12) in one or more spiral(s), said one or more spiral(s) being separated by one or more guard band(s) (5, 15),
wherein the optical system is adapted to perform radial tracking from the reflected light of:
1) the first auxiliary beam (A), the first auxiliary beam being positioned in a first guard (5, 15) band, and
2) the second (B) and third auxiliary beam (C), the second auxiliary beam (B) being positioned substantially on, or next to, a first track (I), and the third auxiliary beam (C) being positioned substantially on, or next to, a second track (II) and on opposite side of the first guard band (5, 15) relative to the second auxiliary beam (B).

2. An optical system according to claim 1, wherein the first (A), second (B) and third auxiliary (C) beams are adapted to be substantially equidistantly positioned on the associated optical record carrier (100).

3. An optical system according to claim 2, wherein the separation distance in the radial direction between the first (A), second (B) and third (B) auxiliary beams is substantially equal to an integer times the track pitch (Tₚ) of the associated optical record carrier (100).

4. An optical system according to claim 1, wherein the first track (I) is adjacent to the first guard band (5, 15), and the second track (II) is adjacent to the first guard band (5, 15).

5. An optical system according to claim 1, wherein each track of the associated carrier (100) is being adapted for recording and/or reproducing optically readable effects positioned substantially in a groove.

6. An optical system according claim 5, wherein the radial tracking is performed according to the push-pull (PP) method.

7. An optical system according to claim 1 comprising at least two corresponding photo detectors (a, b) for each of the first (A), the second (B) and the third (C) auxiliary beam, said at least two photo detectors being adapted to generate a push pull signal (PP_{A}, PP_{B}, PP_{C}) for each auxiliary beam (A, B, C).

8. An optical system according to claim 7, wherein the optical system is adapted to perform a normalization of each push pull signal (PP_{A}, PP_{B}, PP_{C}) by a sum of signals representing the total intensity of reflected light on the at least two photo detectors corresponding to each push pull signal (PP_{A}, PP_{B}, PP_{C}).

9. A method for operating an optical system adapted for reproducing and/or recording optically readable effects on an associated optical record carrier (100), the method comprising the steps of:
providing light providing means (4, 7, 22) capable of emitting at least:
a main beam (52) for reading information as readable effects on the carrier and/or recording information as readable effects on the carrier, and
a plurality of auxiliary beams applicable for radial tracking, said plurality of auxiliary beams comprising a first (A), a second (B) and a third (C) auxiliary beam,
providing photo detection means (101, 110, 120, 130) capable of detecting reflected light (8) from the optical record carrier,
the associated optical record carrier comprising, or being adapted for recording, readable effects arranged in tracks (2, 12) in one or more spiral(s), said one or more spiral(s) being separated by one or more guard band(s) (5, 15),
wherein the optical system is adapted to perform radial tracking by:
detecting the reflected light of the first auxiliary beam (A), the first auxiliary beam being positioned in a first guard band (5, 15), and
the reflected light of the second (B) and third auxiliary beam (C), the second auxiliary beam (B) being positioned substantially on, or next to, a first track (I), and the third auxiliary beam (C) being positioned substantially on, or next to, a second track (II) and on opposite side of the first guard band (5, 15) relative to the second auxiliary beam (B).

10. A computer program product being adapted to enable a computer system comprising at least one computer having data storage means associated therewith to control an optical system according to claim 9.
